(19) United States
(12) Patent Application Publication
(10) Pub. No.: US 2009/0225290 A1
(43) Pub. Date: Sep. 10, 2009

(54) EXPOSURE APPARATUS AND DEVICE FABRICATION METHOD

(75) Inventors: Shinichi Shima, Utsunomiya-shi (JP); Tomohiko Yoshida, Utsunomiya-shi (JP); Ichiro Tanaka, Utsunomiya-shi (JP); Keiko Chiba, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/395,947

(22) Filed: Mar. 2, 2009

(30) Foreign Application Priority Data
Mar. 6, 2008 (JP) 2008-056624

(51) Int. Cl. G03B 27/52

(52) U.S. Cl. 355/30; 355/77

(57) ABSTRACT

The present invention provides an exposure apparatus which exposes a substrate via a liquid, the apparatus including a projection optical system configured to project a pattern of a reticle onto the substrate, a liquid supply unit configured to supply the liquid between the projection optical system and the substrate, a blowing nozzle which is arranged around the projection optical system on a side of the substrate and configured to blow a gas around the liquid supplied between the projection optical system and the substrate, and an exhaust unit configured to exhaust the gas in a space between the blowing nozzle and the liquid supplied between the projection optical system and the substrate, the exhaust unit including a removal member configured to remove a volatile component which volatilizes from the liquid and is contained in the gas in the space.

### BACKGROUND OF THE INVENTION

1. Field of the Invention

The present invention relates to an exposure apparatus and a device fabrication method.

2. Description of the Related Art

An exposure apparatus has conventionally been employed to fabricate a micropatterned semiconductor device such as a semiconductor memory or logic circuit by using photolithography. The exposure apparatus projects and transfers a circuit pattern formed on a reticle (mask) onto a substrate such as a wafer by a projection optical system.

A minimum feature size (resolution) that the exposure apparatus can transfer is proportional to the wavelength of the exposure light, and is inversely proportional to the numerical aperture (NA) of the projection optical system. To keep up with demands for advances in micropatterning of semiconductor devices, the wavelength of the exposure light is shortening, and the NA of the projection optical system is increasing. In recent years, the so-called immersion technique of filling the space between the wafer and the final lens (final surface) of the projection optical system is attracting a great deal of attention as a technique for improving the resolution of the exposure apparatus (see Japanese Patent Laid-Open No. 2005-19864). The resolution of the exposure apparatus when, for example, the space between the wafer and the final lens of the projection optical system is filled with pure water (refractive index=1.33) is 1.33 times that when it is filled with a gas (air). As the liquid (to be referred to as an “immersion material” hereinafter) which fills the space between the wafer and the final lens of the projection optical system, a liquid (high-index liquid) having a refractive index higher than that of pure water is also under development (see Japanese Patent Laid-Open No. 2007-180450). Water added with a salt or an inorganic acid such as H₃PO₄, alcohol derivatives such as glycerol, and hydrocarbon-based organic liquids, for example, have been proposed as the immersion materials.

The exposure apparatus is generally accommodated in a chamber including a temperature adjusting circulation system which adjusts the temperature of the internal gas of the chamber and circulates it, and a chemical filter which removes chemical impurities in the chamber, in order to stabilize the apparatus environment (see Japanese Patent Laid-Open No. 9-280640). Japanese Patent Laid-Open No. 9-280640 discloses a technique of forming a chemical filter by stacking a plurality of thin filters. In this technique, only the filter on the upstream side, whose capacity to remove chemical impurities has degraded, is discarded, and the filter on the downstream side is used continuously. This makes it possible to efficiently exploit the removal capacity of the chemical filter.

Japanese Patent Laid-Open No. 2006-108581 proposes an exposure apparatus including a plurality of wafer stages in order to improve the throughput (productivity) and the alignment accuracy.

When a chemical filter is used in the exposure apparatus, it is important to suppress the running cost of the chemical filter. However, when a chemical filter is used in an immersion exposure apparatus which uses a high-index liquid as disclosed in Japanese Patent Laid-Open No. 2007-180450 as the immersion material, the following problems are posed.

Volatile components (a gas containing volatile components) which volatilize from the high-index liquid are removed by the chemical filter of the temperature adjusting circulation system. However, a high-index liquid is highly volatile, so its use shortens the lifetime (or increases the replacement frequency) of the chemical filter, resulting in an increase in the running cost. In replacing the chemical filter, the exposure apparatus including the temperature adjusting circulation system must be stopped. This increases the replacement frequency of the chemical filter, resulting in a decrease in the throughput of the exposure apparatus.

Furthermore, volatile components of the high-index liquid are often harmful (they are, for example, inflammable), so it is necessary to prevent their scattering over the entire exposure apparatus. It is also necessary to exhaust the internal gas (a gas containing volatile components) of the exposure apparatus to the outside after surely removing or reducing volatile components contained in the gas.

When the immersion exposure apparatus includes a plurality of wafer stages, the volume of the stage space increases. To stabilize the thermal environment of that space, it is necessary to, for example, supply a large amount of temperature-adjusted gas. This increases the flow rate of the gas which circulates through the apparatus. It is therefore necessary to increase the size of the chemical filter of the temperature adjusting circulation system, increase the number of chemical filters used, and frequently replace the chemical filter, resulting in an increase in the running cost.

A resin-based material used as a seal member in the exposure apparatus generally has no resistance to volatile components of the high-index liquid, resulting in a decrease in the seal function of the seal member due to its deterioration.

### SUMMARY OF THE INVENTION

The present invention provides an exposure apparatus which can suppress an increase in the running cost and a decrease in the throughput even when a high-index liquid is used as the immersion material.

According to one aspect of the present invention, there is provided an exposure apparatus which exposes a substrate via a liquid, the apparatus comprising a projection optical system configured to project a pattern of a reticle onto the substrate, a liquid supply unit configured to supply the liquid between the projection optical system and the substrate, a blowing nozzle which is arranged around the projection optical system on a side of the substrate and configured to blow a gas around the liquid supplied between the projection optical system and the substrate, and an exhaust unit configured to exhaust the gas in a space between the blowing nozzle and the liquid supplied between the projection optical system and the substrate, the exhaust unit including a removal member configured to remove a volatile component which volatilizes from the liquid and is contained in the gas in the space.

Further aspects and features of the present invention will become apparent from the following description of exemplary embodiments with reference to the attached drawings.

### BRIEF DESCRIPTION OF THE DRAWINGS

FIG. 1 is a schematic view showing an exposure apparatus according to one aspect of the present invention.

FIG. 2 is a schematic view showing an exposure apparatus main unit of the exposure apparatus shown in FIG. 1.

FIG. 3 is an enlarged sectional view of the vicinity of the final surface (the surface closest to a wafer) of a projection optical system of the exposure apparatus shown in FIG. 1.

FIG. 4 is a schematic view showing an example of an exhaust unit shown in FIG. 3.

FIG. 5 is a schematic view showing another example of the exhaust unit shown in FIG. 3.

FIG. 6 is a schematic view showing still another example of the exhaust unit shown in FIG. 3.

FIG. 7 is a schematic view showing another arrangement of the exposure apparatus main unit of the exposure apparatus shown in FIG. 1.

FIG. 8 is a schematic view showing an exposure apparatus according to one aspect of the present invention.

### DESCRIPTION OF THE EMBODIMENTS

Preferred embodiments of the present invention will be described below with reference to the accompanying drawings. The same reference numerals denote the same members throughout the drawings, and a repetitive description thereof will not be given.

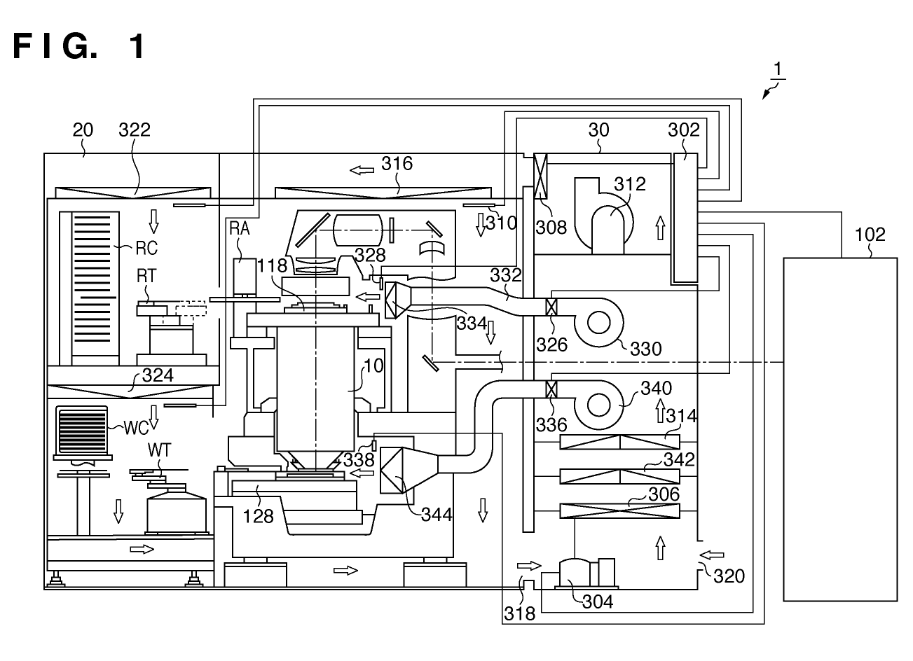

FIG. 1 is a schematic view showing an exposure apparatus 1 according to one aspect of the present invention. The exposure apparatus 1 is an immersion exposure apparatus which transfers the pattern of a reticle onto a substrate such as a wafer by the step & scan scheme via a liquid supplied between a projection optical system and the substrate. However, the exposure apparatus 1 can adopt the step & repeat scheme or another exposure scheme.

The exposure apparatus 1 includes an exposure apparatus main unit 10, chamber 20, and temperature adjusting circulation system 30, as shown in FIG. 1.

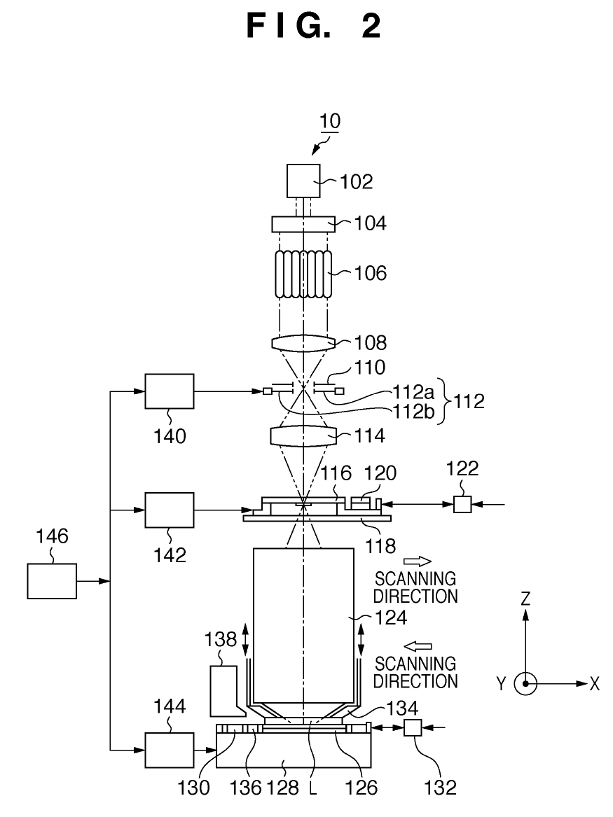

The exposure apparatus main unit 10 includes a light source 102 and an illumination optical system including a shaping optical system 104, fly-eye lens 106, condenser lens 108, field stop 110, movable blind (variable field stop) 112, and relay lens system 114, as shown in FIG. 2. The exposure apparatus main unit 10 also includes a reticle stage 118 which mounts a reticle 116 and reference plate 120, an interferometer 122, a projection optical system 124, and a wafer stage 128 which mounts a wafer 126. The exposure apparatus main unit 10 also includes an interferometer 132, liquid supply/exhaust mechanism 134, liquid holding plate 136, alignment detection system 138, movable blind control unit 140, reticle stage control unit 142, wafer stage control unit 144, and main control unit 146. Note that FIG. 2 is a schematic view showing the exposure apparatus main unit 10.

The light source 102 is, for example, a KrF excimer laser having a wavelength of about 248 nm, an ArF excimer laser having a wavelength of about 193 nm, or an F₂ laser having a wavelength of about 157 nm. Alternatively, the light source 102 can be, for example, a pulse light source such as a metal vapor laser or YAG laser, or a continuous light source as a combination of a mercury lamp and an elliptic mirror.

If the light source 102 is a pulse light source, exposure is switched on/off by controlling power supplied to the pulse light source. If the light source 102 is a continuous light source, exposure is switched on/off by a shutter arranged in the shaping optical system 104. However, since the exposure apparatus 1 includes the movable blind 112 in this embodiment, exposure may be switched on/off by opening/closing the movable blind 112.

The shaping optical system 104 shapes light (illumination light) from the light source 102 (for example, shapes the light to have a predetermined beam diameter), and guides it to the fly-eye lens 106.

The fly-eye lens 106 forms a large number of secondary light sources on its exit surface.

The condenser lens 108 converges the light from the large number of secondary light sources formed on the exit surface of the fly-eye lens 106, and guides it to the movable blind 112 via the field stop 110.

Although the field stop 110 is set closer to the condenser lens 108 than the movable blind 112 in this embodiment, it may be set closer to the relay lens system 114. The field stop 110 forms a slit-shaped aperture. The light having passed through the field stop 110 turns into that having a slit-shaped section, and enters the relay lens system 114.

The movable blind 112 includes two light-shielding plates 112a and 112b which define the dimension in the scanning direction (the X-axis direction), and two light-shielding plates (not shown) which define the dimension in a direction (the non-scanning direction, that is, the Y-axis direction) perpendicular to the scanning direction. The light-shielding plates 112a and 112b can be independently driven in the scanning direction. Likewise, the two light-shielding plates which define the dimension in the non-scanning direction can be independently driven in the non-scanning direction. In this embodiment, the light is applied to only an exposure region defined by the movable blind 112 in an illumination region on the reticle 116, which is defined by the field stop 110.

The relay lens system 114 sets the movable blind 112 and the reticle 116 (more specifically, the pattern surface of the reticle 116) to be conjugate to each other. The relay lens system 114 is a bilateral telecentric optical system whose telecentricity is maintained in the illumination region on the reticle 116.

The reticle 116 has a circuit pattern and is held and driven by the reticle stage 118. The reticle 116 is illuminated with a uniform illuminance by the slit-shaped illumination region formed by the light source 102 and illumination optical system. Note that a reticle 116 is accommodated in a reticle accommodation unit RC and picked up and transported to a reticle alignment unit RA by a reticle transport system RT, as shown in FIG. 1. The reticle 116 transported to the reticle alignment unit RA is aligned and held by the reticle stage 118.

The reticle stage 118 holds the reference plate 120, on which a calibration reference mark is formed, together with the reticle 116. The reticle stage 118 scans the reticle 116 in the scanning direction (the X-axis direction).

The interferometer 122 detects the position (for example, the position in the X- and Y-axis directions and the rotation directions about the X- and Y-axes) of the reticle stage 118.

The projection optical system 124 projects the circuit pattern (more specifically, a circuit pattern positioned in the exposure region defined by the movable blind 112 in the slit-shaped illumination region) of the reticle 116 onto the wafer 126.

The wafer 126 is a substrate which is held by the wafer stage 128 and onto which the circuit pattern of the reticle 116 is projected (transferred). However, the wafer 126 can be substituted by a glass plate or another substrate. Note that a wafer 126 is accommodated in a wafer accommodation unit WC and picked up by a wafer transport system WT, as shown in FIG. 1. The wafer 126 picked up by the wafer transport system WT is transported through a wafer feed unit and held by the wafer stage 128.

The wafer stage 128 holds the wafer 126 by chucking it by vacuum suction through a wafer chuck. The wafer stage 128 includes an X-Y stage which aligns the wafer 126 in a plane perpendicular to the optical axis of the projection optical system 124 and scans it in the scanning direction (the X-axis direction), and a Z stage which aligns the wafer 126 in the optical axis direction of the projection optical system 124. A reference mark 130 for calibration or alignment of the wafer 126 is formed on the wafer stage 128. Also, a measuring unit (not shown) which can measure, for example, the imaging performance of the projection optical system 124 and the illuminance on the wafer 126 is arranged on the wafer stage 128.

The interferometer 132 detects the position (for example, the position in the X- and Y-axis directions and the rotation directions about the X- and Y-axes) of the wafer stage 128.

The liquid supply/exhaust mechanism 134 includes a liquid supply unit which supplies a liquid L between the projection optical system 124 and the wafer 126, and a liquid recovery unit which recovers the liquid L supplied between the projection optical system 124 and the wafer 126. The liquid supply unit includes, for example, a liquid supply pipe, pump, liquid temperature adjusting unit, and filter. The liquid recovery unit includes, for example, a liquid recovery pipe, pump, and gas-liquid separation unit.

The liquid L preferably has a high transmittance with respect to the exposure light, and a refractive index higher than those of quartz and calcium fluoride. In this embodiment, the liquid L is a liquid (organic liquid) having a refractive index higher than 1.33.

The liquid holding plate 136 is arranged around the wafer 126 while being chucked by vacuum suction by the wafer stage 128, and has a surface flush with that of the wafer 126. The liquid holding plate 136 holds the liquid L, which is supplied between the projection optical system 124 and the wafer 126, in the periphery of the wafer 126.

In this embodiment, the alignment detection system 138 is an off-axis detection system and detects the alignment mark formed on the wafer 126.

The movable blind control unit 140 controls driving of the movable blind 112 (the two light-shielding plates 112a and 112b which define the dimension in the scanning direction, and the two light-shielding plates which define the dimension in the non-scanning direction).

The reticle stage control unit 142 controls driving of the reticle stage 118 (e.g., the alignment operation and scanning operation of the reticle stage 118) based on the position of the reticle stage 118 detected by the interferometer 122.

The wafer stage control unit 144 controls driving of the wafer stage 128 (e.g., the alignment operation and scanning operation of the wafer stage 128) based on the position of the wafer stage 128 detected by the interferometer 132, and the detection result obtained by the alignment detection system 138.

The main control unit 146 includes a CPU and memory (neither are shown), and controls, for example, the movable blind control unit 140, reticle stage control unit 142, and wafer stage control unit 144 to control the operation of the exposure apparatus 1 including the exposure apparatus main unit 10. The main control unit 146 also controls supply and recovery of the liquid L through the liquid supply/exhaust mechanism 134.

In transferring the circuit pattern of the reticle 116 to each shot region on the wafer 126, the reticle 116 is scanned at a velocity VR in the X-axis direction (for example, the negative direction) with respect to the slit-shaped illumination region defined by the field stop 110. Also, the wafer 126 is scanned at a velocity β·VR (where β is the projection magnification of the projection optical system 124) in the X-axis direction (for example, the positive direction) in synchronism with the scanning of the reticle 116. With this operation, the circuit pattern of the reticle 116 is transferred to each shot region on the wafer 126 step by step.

Referring back to FIG. 1, the chamber 20 accommodates the entire exposure apparatus 1 including the exposure apparatus main unit 10. More specifically, the chamber 20 accommodates the entire exposure apparatus 1 by partitioning it into a plurality of spaces having an almost airtight structure. In this embodiment, the chamber 20 accommodates the entire exposure apparatus 1 by partitioning it into five spaces, that is, an exposure apparatus main unit space, reticle accommodation unit space, wafer accommodation unit space, reticle stage space, and wafer stage space. Note that the exposure apparatus main unit space accommodates the exposure apparatus main unit 10 except for the light source 102, reticle stage 118, and wafer stage 128. The reticle accommodation unit space accommodates, for example, the reticle accommodation unit RC and reticle transport system RT. The wafer accommodation unit space accommodates, for example, the wafer accommodation unit WC and wafer transport system WT. The reticle stage space accommodates the reticle stage 118. The wafer stage space accommodates the wafer stage 128.

The temperature adjusting circulation system 30 adjusts the temperature of the internal gas of the chamber 20 and circulates it in a circulation channel including the interior of the chamber 20. In this embodiment, the temperature adjusting circulation system 30 adjusts the temperature of the gas for each of the five spaces, that is, the exposure apparatus main unit space, reticle accommodation unit space, wafer accommodation unit space, reticle stage space, and wafer stage space. The temperature adjusting circulation system 30 includes, for example, a thermometer which measures the temperature of the gas in each space, a temperature adjusting device which adjusts the temperature of the gas, and a temperature adjusting circulation system control unit which controls devices such as the temperature adjusting device (that is, it controls the temperature of the gas) based on the measurement result obtained by the thermometer. The temperature adjusting device includes, for example, a refrigerant circulation unit, heat exchanger, and temperature adjusting unit.

A gas temperature-adjusted by a refrigerant circulation unit 304, heat exchanger 306, temperature adjusting unit 308, and thermometer 310 under the control of a temperature adjusting circulation system control unit 302 is supplied to the exposure apparatus main unit space through a fan 312. At this time, the gas supplied to the exposure apparatus main unit space is clean as it passes through a chemical filter 314 and dust removal filter 316 arranged in the gas flow channel in the chamber 20. The chemical filter means a filter which removes chemical impurities contained in the internal gas of the chamber 20. The gas supplied to the exposure apparatus main unit space returns to the temperature adjusting device through a return unit 318, and is temperature-adjusted again by the refrigerant circulation unit 304, heat exchanger 306, temperature adjusting unit 308, and thermometer 310. Note that the exposure apparatus main unit space has an almost airtight structure, as mentioned above, and has a positive pressure with respect to the exterior of the chamber 20. Note also that, in this embodiment, an outside air intake 320 for taking in the air outside the chamber 20 (outside air) is provided in order to suppress leakage of the gas from the exposure apparatus main unit space.

In each of the reticle accommodation unit space and wafer accommodation unit space, a circulation system is configured by a refrigerant circulation unit, heat exchanger, temperature adjusting unit, thermometer, and fan under the control of the temperature adjusting circulation system control unit 302, as in the exposure apparatus main unit space. Gases supplied to the reticle accommodation unit space and wafer accommodation unit space are clean as they pass through dust removal filters 322 and 324. The gases supplied to the reticle accommodation unit space and wafer accommodation unit space return to the temperature adjusting device through the return unit 318.

A gas temperature-adjusted by the refrigerant circulation unit 304, the heat exchanger 306, a temperature adjusting unit 326, and a thermometer 328 under the control of the temperature adjusting circulation system control unit 302 is supplied to the reticle stage space through a fan 330 and duct 332. At this time, the gas supplied to the reticle stage space is clean as it passes through a dust removal filter 334. The gas supplied to the reticle stage space returns to the temperature adjusting device through the return unit 318.

A gas temperature-adjusted by the refrigerant circulation unit 304, the heat exchanger 306, a temperature adjusting unit 336, and a thermometer 338 under the control of the temperature adjusting circulation system control unit 302 is supplied to the wafer stage space through a fan 340 and duct. At this time, the gas supplied to the reticle stage space is clean as it passes through a dust removal filter 344.

Note that the wafer stage space contains volatile components which volatilize from the liquid L because it stores the liquid L. Accordingly, the gas which returns to the temperature adjusting device from the wafer stage space contains volatile components which volatilize from the liquid L. To cope with this situation, in this embodiment, a removal member 342 which removes volatile components which volatilize from the liquid L is arranged in the circulation channel of the temperature adjusting circulation system 30 upstream of the chemical filter 314 in the direction in which the internal gas of the chamber 20 flows. The removal member 342 can be, for example, activated carbon which has chemical properties different from those of the chemical filter 314, absorbs volatile components which volatilize from the liquid L, and is less expensive than the chemical filter 314. With this arrangement, the gas which has returned to the temperature adjusting device from the wafer stage space and contains volatile components which volatilize from the liquid L passes through the chemical filter 314 after volatile components which volatilize from the liquid L are removed by the removal member 342. This makes it possible to prevent shortening of the lifetime (i.e., an increase in the replacement frequency) of the chemical filter 314 due to volatile components which volatilize from the liquid L because the chemical filter 314 need not remove the volatilized components which volatilize from the liquid L. It is therefore possible to suppress an increase in the running cost and a decrease in the throughput even when a liquid (organic liquid) having a refractive index higher than 1.33 is used as the liquid L. Note that removing (absorbing) volatile components which volatilize from the liquid L by the removal member 342 makes it possible to prevent an increase in the density of volatile components contained in the internal gas of the chamber 20.

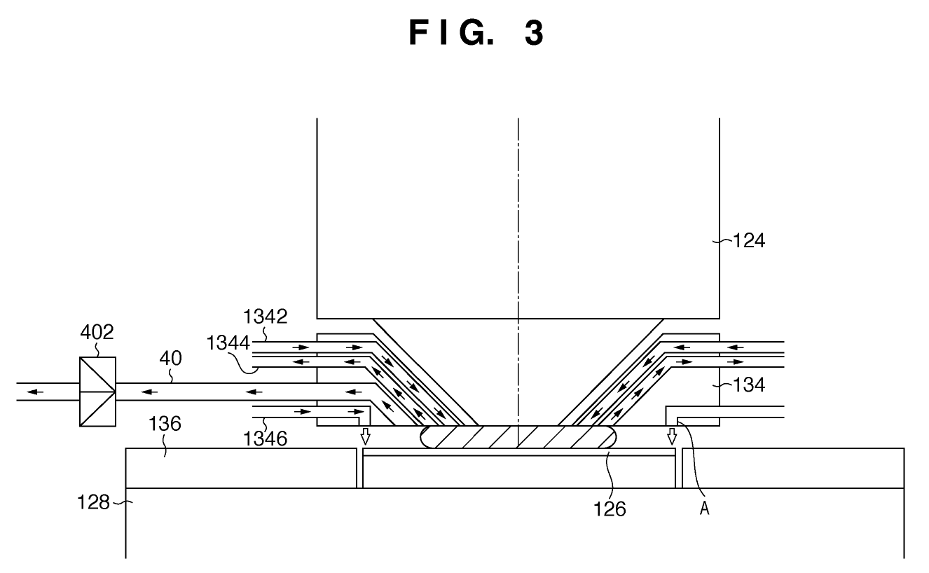

The gas around the liquid L supplied between the projection optical system 124 and the wafer 126, that is, a gas containing a large amount of volatile components which volatilize from the liquid L may be exhausted outside the chamber 20, as shown in FIG. 3. There exists an interface with the gas around the liquid L, in which volatile components volatilize from the liquid L. In addition, the liquid L moves on the wafer 126 or on the liquid holding plate 136 upon driving the wafer stage 128, so volatile components volatilize from the liquid L as it stays behind the wafer 126 or the liquid holding plate 136. Therefore, a gas containing a large amount of volatile components which volatilize from the liquid L is present around the liquid L. FIG. 3 is an enlarged sectional view of the vicinity of the final surface (the surface closest to the wafer 126) of the projection optical system 124.

Referring to FIG. 3, a liquid supply pipe 1342 and liquid recovery pipe 1344 of the liquid supply/exhaust mechanism 134 are arranged near the final surface of the projection optical system 124. A blowing nozzle 1346 which blows a gas to the periphery of the liquid L is arranged outside the liquid recovery pipe 1344 (i.e., in the periphery of the projection optical system 124 on its substrate side) in order to stably maintain the liquid L supplied between the projection optical system 124 and the wafer 126. The blowing nozzle 1346 blows a gas to the periphery of the liquid L to form an air curtain, thereby limiting the space, in which a gas containing a large amount of volatile components which volatilize from the liquid L is present, to a partial space. It is therefore possible to efficiently exhaust a gas containing a large amount of volatile components which volatilize from the liquid L by inserting an exhaust unit 40 between the liquid recovery pipe 1344 and the blowing nozzle 1346 and exhausting the gas in the space formed by the air curtain, as shown in FIG. 3. A removal member 402 which removes volatile components which volatilize from the liquid L is arranged in the exhaust channel of the exhaust unit 40. This makes it possible to exhaust the gas by removing or reducing volatile components in the gas. The removal member 402 is activated carbon, as in the removal member 342.

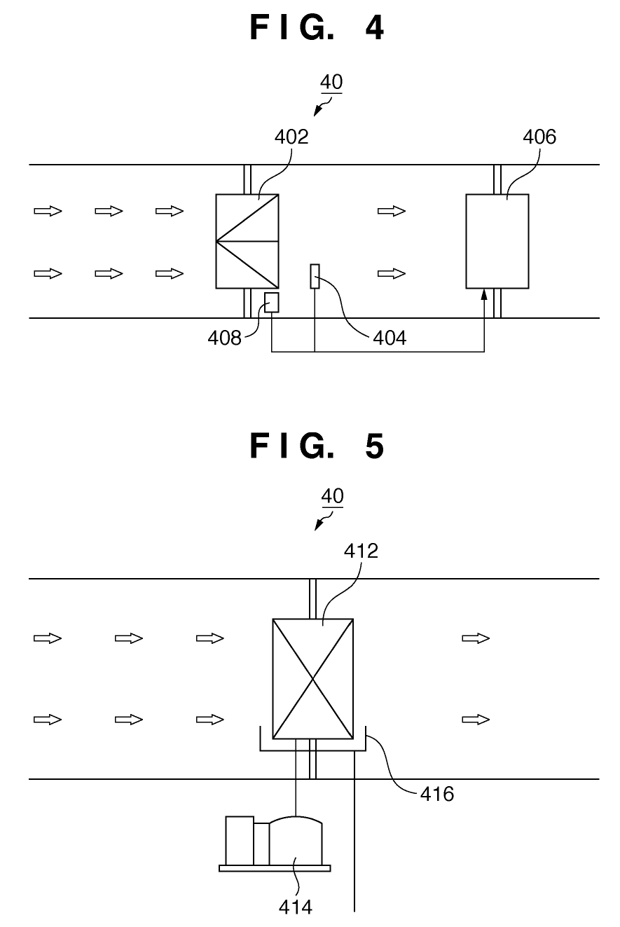

The exhaust unit 40 preferably has an arrangement as shown in FIG. 4 in order to exhaust the gas by surely removing or reducing volatile components which volatilize from the liquid L. In addition to the removal member 402, the exhaust unit 40 shown in FIG. 4 includes a density detection unit 404 which detects the density of volatile components which volatilize from the liquid L, a shutoff unit 406 which shuts off the exhaust channel, and a detection unit 408 which detects whether the removal member 402 is arranged in the exhaust channel. FIG. 4 is a schematic view showing an example of the exhaust unit 40. In FIG. 4, the arrows indicate the flow (flow direction) of a gas which contains volatile components that volatilize from the liquid L and is exhausted by the exhaust unit 40.

Referring to FIG. 4, a gas containing volatile components which volatilize from the liquid L undergoes removal of the volatile components and is exhausted outside the chamber 20. Note that as the removal member 402 removes volatile components which volatilize from the liquid L, its capacity to remove volatile components degrades. For this reason, it often becomes impossible for the removal member 402 to sufficiently remove or reduce volatile components which volatilize from the liquid L. In this case, the exhaust unit 40 exhausts the gas still containing volatile components which volatilize from the liquid L.

To solve this problem, the density detection unit 404 is arranged in the exhaust channel of the exhaust unit 40 downstream of the removal member 402, and detects the density of volatile components contained in the gas having passed through the removal member 402. If the density of volatile components detected by the density detection unit 404 is equal to or higher than a threshold, the exhaust is stopped by shutting off the exhaust channel by the shutoff unit 406. With this operation, a gas containing volatile components which volatilize from the liquid L and have a density equal to or higher than a threshold can be prevented from being exhausted outside the chamber 20. In other words, only a gas having surely undergone removal or reduction of volatile components which volatilize from the liquid L can be exhausted outside the chamber 20. It is also possible to detect the density of oxygen contained in the gas having passed through the removal member 402 by the density detection unit 404, and determine that the density of volatile components contained in the gas is equal to or higher than a threshold if the density of oxygen is equal to or lower than a predetermined density.

When the removal member 402 has reached the end of its lifetime (that is, it has lost the capacity to remove volatile components), it can no longer remove volatile components which volatilize from the liquid L contained in the gas. To cope with this situation, the removal member 402 is detachably arranged in the exhaust channel of the exhaust unit 40 for replacement. When the removal member 402 having reached the end of its lifetime is replaced, it is not arranged in the exhaust channel of the exhaust unit 40, so a gas containing volatile components which volatilize from the liquid L is exhausted directly.

To avoid this situation, the detection unit 408 is arranged in the exhaust channel of the exhaust unit 40, and detects whether the removal member 402 is arranged in the exhaust channel. If the detection unit 408 determines that the removal member 402 is not arranged in the exhaust channel of the exhaust unit 40, the exhaust is stopped by shutting off the exhaust channel by the shutoff unit 406. With this operation, a gas containing volatile components which volatilize from the liquid L can be prevented from being exhausted directly. In other words, only a gas having surely undergone removal or reduction of volatile components which volatilize from the liquid L can be exhausted outside the chamber 20. Note that the shutoff unit 406 keeps the exhaust channel of the exhaust unit 40 shut off until the detection unit 408 detects that the removal member 402 is arranged in the exhaust channel.

Such an arrangement (the density detection unit 404, shutoff unit 406, and detection unit 408) which exhausts only a gas having surely undergone removal or reduction of volatile components which volatilize from the liquid L to the outside of the chamber 20 is also applicable to the removal member 342 shown in FIG. 1. This makes it possible to prevent a gas containing volatile components which volatilize from the liquid L and have a density equal to or higher than a threshold from circulating through the chamber 20.

Instead of being absorbed by activated carbon serving as the removal member 342, volatile components which volatilize from the liquid L can be removed by cooling a gas containing volatile components which volatilize from the liquid L, as shown in FIG. 5. FIG. 5 is a schematic view showing another example of the exhaust unit 40. The exhaust unit 40 shown in FIG. 5 includes a heat exchanger 412, refrigerant circulation system 414, and recovery unit 416. In FIG. 5, the arrows indicate the flow (flow direction) of a gas which contains volatile components which volatilize from the liquid L and is exhausted by the exhaust unit 40.

Referring to FIG. 5, the heat exchanger 412 cools a gas containing volatile components which volatilize from the liquid L. The heat exchanger 412 is set to a temperature equal to or lower than that, at which volatile components which volatilize from the liquid L condense, by the refrigerant circulation system 414. Accordingly, volatile components which volatilize from the liquid L and are contained in the gas are condensed by the heat exchanger 412 and removed from the gas. The volatile components (i.e., the liquid L) which are condensed by the heat exchanger 412 are recovered by a recovery unit 416 including, for example, a drain pan and drain. In this manner, the exhaust unit 40 shown in FIG. 5 can exhaust a gas containing volatile components which volatilize from the liquid L after removing or reducing the volatile components by cooling the gas to a predetermined temperature (the temperature at which volatile components condense) or less. A gas containing volatile components which volatilize from the liquid L and have a density equal to or higher than a threshold may be prevented from being exhausted outside the chamber 20 by arranging the density detection unit 404 and shutoff unit 406, as shown in FIG. 4, downstream of the heat exchanger 412.

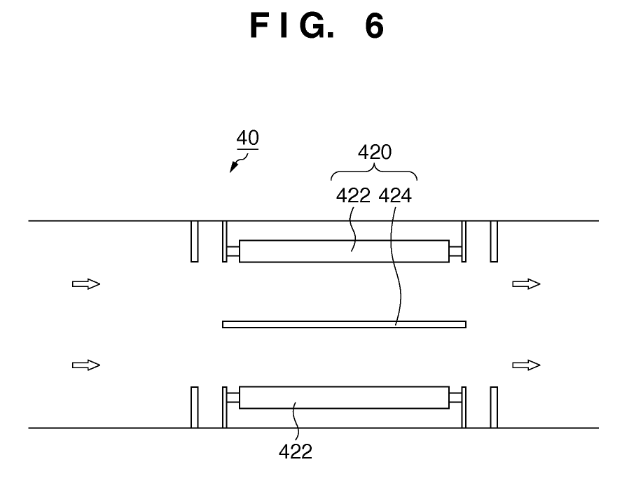

Since volatile components which volatilize from the liquid L and are contained in the gas are generally organic components, they can be removed upon being chemically decomposed using a photochemical reaction, as shown in FIG. 6. FIG. 6 is a schematic view showing still another example of the exhaust unit 40. The exhaust unit 40 shown in FIG. 6 includes a decomposing unit 420. The decomposing unit 420 includes ultraviolet lamps 422 serving as the irradiation units, and a photocatalyst member 424. The ultraviolet lamps 422 are arranged in the exhaust channel of the exhaust unit 40 to face the photocatalyst member 424 having a thin film of a photocatalyst (for example, titanium oxide) on its surface. In FIG. 6, the arrows indicate the flow (flow direction) of a gas which contains volatile components which volatilize from the liquid L and is exhausted by the exhaust unit 40.

Referring to FIG. 6, a gas containing volatile components which volatilize from the liquid L contacts the photocatalyst member 424 which is excited upon being irradiated with ultraviolet rays from the ultraviolet lamps 422. With this operation, because volatile components which volatilize from the liquid L and are contained in the gas undergo oxidative decomposition and are removed from the gas, the exhaust unit 40 shown in FIG. 6 can exhaust the gas after removing or reducing the volatile components. Although the volatile components are decomposed using the ultraviolet lamps 422 and the photocatalyst member 424 as the decomposing unit 420 in this embodiment, they may undergo oxidative decomposition by ozone generated by irradiating the gas with ultraviolet rays. Alternatively, a gas containing volatile components which volatilize from the liquid L and have a density equal to or higher than a threshold may be prevented from being exhausted outside the chamber 20 by arranging the density detection unit 404 and shutoff unit 406, as shown in FIG. 4, downstream of the decomposing unit 420.

Although the exhaust unit 40 exhausts the gas around the liquid L supplied between the projection optical system 124 and the wafer 126 in this embodiment, it is also applicable to a case in which the internal gas of the chamber 20 is exhausted outside without being circulated through it.

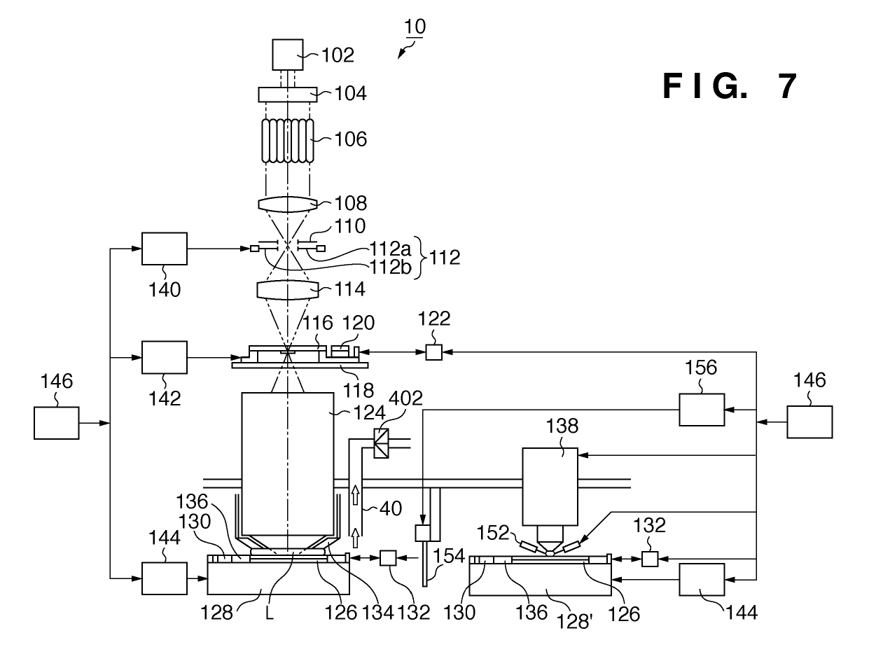

The exposure apparatus main unit 10 often includes a plurality of wafer stages (for example, two wafer stages 128 and 128′), as shown in FIG. 7. FIG. 7 is a schematic view showing another arrangement of the exposure apparatus main unit 10. The two wafer stages 128 and 128′ can move between an exposure area in which the wafer 126 is exposed and a measurement area in which the wafer 126 is measured. An alignment detection system 138 which detects an alignment mark formed on the wafer 126 is set in the measurement area. A surface detection system 152 which detects the surface state, such as the level and tilt, of the wafer 126, and the like are also set in the measurement area.

A partition plate 154 for partitioning the exposure area and the measurement area is interposed between the exposure area and the measurement area, as shown in FIG. 7. The partition plate 154 can be driven vertically and is controlled by a partition plate control unit 156. For example, under the control of the partition plate control unit 156, the partition plate 154 is driven vertically when the wafer stages 128 and 128′ move between the exposure area and the measurement area.

When the wafer 126 is exposed in the exposure area, a liquid L is supplied between the projection optical system 124 and the wafer 126, and the liquid L supplied between the projection optical system 124 and the wafer 126 is recovered. Therefore, a gas containing a large amount of volatile components which volatilize from the liquid L is present in the space around the liquid L in the exposure area.

To cope with this situation, when the wafer 126 is exposed in the exposure area, the partition plate 154 inserted between the exposure area and the measurement area is driven downwards to partition the space into an exposure area and a measurement area. This makes it possible to limit the space, in which a gas containing volatile components which volatilize from the liquid L is present, to the exposure area. Therefore, an exhaust unit 40 including a removal member 402 which removes volatile components which volatilize from the liquid L need only be set in the exposure area. In this manner, even when the wafer stage space widens by providing a plurality of wafer stages, limiting the space in which a gas containing volatile components which volatilize from the liquid L makes it possible to prevent an increase in the size of the exhaust unit 40 (removal member 402), thus preventing an increase in the running cost. Although the partition plate 154 preferably perfectly partitions the exposure area and the measurement area, it is only necessary that the partition plate 154 serve to decrease the density of volatile components which volatilize from the liquid L and are contained in the gas in the measurement area. Although the partition plate 154 can be driven vertically in this embodiment, it may be fixed as long as the two wafer stages 128 and 128′ can move between the exposure area and the measurement area. In place of the partition plate 154, a forming unit which forms an air curtain for partitioning the exposure area and the measurement area may be provided.

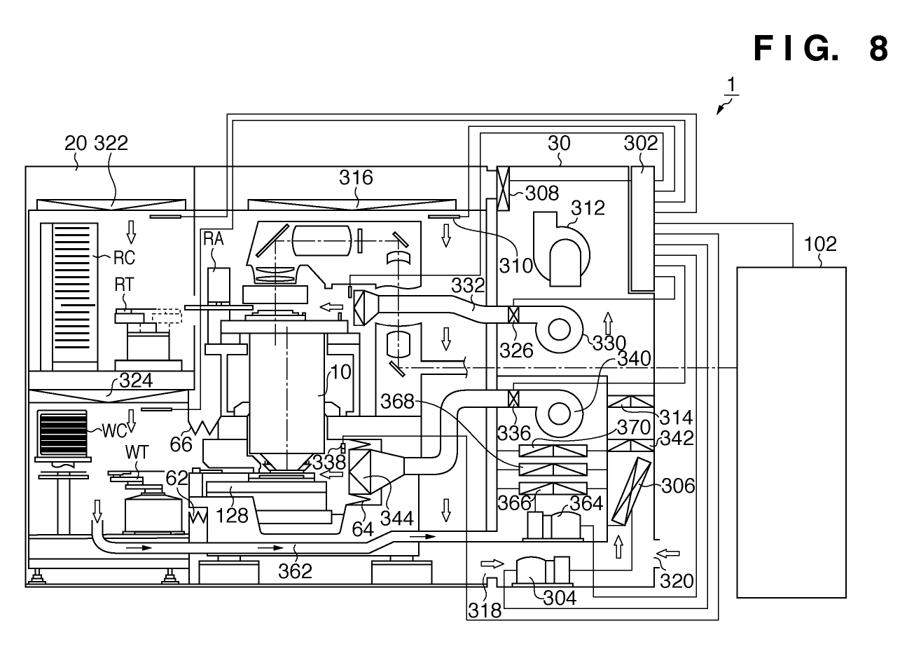

A gas containing a large amount of volatile components which volatilize from the liquid L is present in the wafer stage space, as mentioned above, so the wafer stage space is preferably maintained airtight using seal members 62, 64, and 66, as shown in FIG. 8. FIG. 8 is a schematic view showing an exposure apparatus 1 according to one aspect of the present invention.

Referring to FIG. 8, the wafer stage space is set to have an airtight structure by the seal members 62, 64, and 66, and supplied with a temperature-adjusted gas from the temperature adjusting circulation system 30. The gas supplied to the wafer stage space flows through the wafer accommodation unit space and returns to the temperature adjusting device through a return unit 362 having a channel different from the channel of the return unit 318. In the temperature adjusting device, the gas having returned from the wafer stage space is cooled by a refrigerant circulation unit 364 and heat exchanger 366 so that volatile components which volatilize from the liquid L and are contained in the gas are removed by a removal member 368 including, for example, activated carbon. The gas from which volatile components which volatilize from the liquid L are removed undergoes removal of chemical impurities by a chemical filter 370, is temperature-adjusted by a thermometer 338 and temperature adjusting unit 336, and is supplied to the wafer stage space through a fan 340 and duct.

Although a material, which has elasticity and flexibility, such as rubber or a resin is preferably used as the seal members 62, 64, and 66, it generally has no resistance to volatile components which volatilize from the liquid L. In view of this, the seal members 62, 64, and 66 are made of a bellows metal having a resistance to volatile components which volatilize from the liquid L so that the seal functions of the seal members 62, 64, and 66 are suppressed from degrading due to the presence of the volatile components, thus maintaining the airtightness of the wafer stage space. Alternatively, the seal members 62, 64, and 66 may be made of a flexible member (for example, rubber or a resin) having, on its surface, a metal having a resistance to volatile components which volatilize from the liquid L. Although three seal members 62, 64, and 66 are used in this embodiment, the present invention is not particularly limited to this, and four seal members, for example, may be used. The seal members 62, 64, and 66 can be used not only to set the wafer stage space to have an airtight structure but also set other spaces to have an airtight structure.

In this manner, the exposure apparatus 1 can suppress an increase in the running cost and a decrease in the throughput even when a high-index liquid is used as the liquid L supplied between the projection optical system 124 and the wafer 126. Hence, the exposure apparatus 1 can provide high-quality devices (e.g., a semiconductor device and a liquid crystal display device with a high throughput and a good economical efficiency. The devices are fabricated by a step of exposing a substrate (e.g., a wafer or a glass plate) coated with a photoresist (photosensitive agent) using the exposure apparatus 1, a step of developing the exposed substrate, and other known steps.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-056624 filed on Mar. 6, 2008, which is hereby incorporated by reference herein in its entirety.

What is claimed is:

1. An exposure apparatus which exposes a substrate via a liquid, the apparatus comprising:
a projection optical system configured to project a pattern of a reticle onto the substrate;
a liquid supply unit configured to supply the liquid between said projection optical system and the substrate;
a blowing nozzle which is arranged around said projection optical system on a side of the substrate and configured to blow a gas around the liquid supplied between said projection optical system and the substrate; and
an exhaust unit configured to exhaust the gas in a space between said blowing nozzle and the liquid supplied between said projection optical system and the substrate,
said exhaust unit including a removal member configured to remove a volatile component which volatilizes from the liquid and is contained in the gas in the space.

2. The apparatus according to claim 1, wherein said removal member includes activated carbon configured to absorb the volatile component which volatilizes from the liquid.

3. The apparatus according to claim 1, further comprising a seal member configured to maintain a space which stores the liquid airtight,
wherein said seal member is a flexible member having, on a surface thereof, a metal having a resistance to the volatile component which volatilizes from the liquid, or a bellows metal having a resistance to the volatile component which volatilizes from the liquid.

4. The apparatus according to claim 1, wherein the liquid has a refractive index higher than 1.33.

5. An exposure apparatus comprising:
an exposure apparatus main unit configured to expose a substrate via a liquid;
a chamber configured to accommodate said exposure apparatus main unit; and
an exhaust unit configured to exhaust an internal gas of said chamber to the outside through an exhaust channel,
said exhaust unit including a removal member configured to remove a volatile component which volatilizes from the liquid and is contained in the gas.

6. The apparatus according to claim 5, further comprising:
a density detection unit which is arranged in an exhaust channel of said exhaust unit and configured to detect a density of the volatile component contained in the gas having passed through said removal member; and
a shutoff unit configured to shut off the exhaust channel of said exhaust unit if the density of the volatile component detected by said density detection unit is not less than a threshold.

7. The apparatus according to claim 6, further comprising a detection unit configured to detect whether said removal member is arranged in the exhaust channel of said exhaust unit,
wherein said shutoff unit shuts off the exhaust channel of said exhaust unit if said detection unit detects that said removal member is not arranged in the exhaust channel of said exhaust unit.

8. An exposure apparatus comprising:
an exposure apparatus main unit configured to expose a substrate via a liquid;
a chamber configured to accommodate said exposure apparatus main unit;
an exhaust unit configured to exhaust an internal gas of said chamber to the outside through an exhaust channel;
a heat exchanger which is arranged in an exhaust channel of said exhaust unit and configured to cool the gas to not more than a temperature, at which a volatile component which volatilizes from the liquid and is contained in the gas condenses; and
a recovery unit configured to recover the liquid cooled and condensed by said heat exchanger.

9. An exposure apparatus comprising:
an exposure apparatus main unit configured to expose a substrate via a liquid;
a chamber configured to accommodate said exposure apparatus main unit;
an exhaust unit configured to exhaust an internal gas of said chamber to the outside through an exhaust channel; and
a decomposing unit configured to decompose a volatile component, which volatilizes from the liquid and is contained in the gas, in the exhaust channel of said exhaust unit.

10. The apparatus according to claim 9, wherein
said decomposing unit includes
a photocatalyst arranged in the exhaust channel of said exhaust unit, and
an irradiation unit which is mounted to face said photocatalyst and configured to irradiate said photocatalyst with ultraviolet rays, and
the volatile component which volatilizes from the liquid is decomposed by a photochemical reaction between the gas and said photocatalyst irradiated with the ultraviolet rays from said irradiation unit.

11. An exposure apparatus comprising:
an exposure apparatus main unit configured to expose a substrate via a liquid;
a chamber configured to accommodate said exposure apparatus main unit;
a chemical filter which is arranged in a flow channel of an internal gas of said chamber and configured to remove a chemical impurity contained in the gas; and
a removal member which is set upstream of said chemical filter in a direction in which the gas flows, has a chemical property different from a chemical property of said chemical filter, and is configured to remove a volatile component which volatilizes from the liquid and is contained in the gas.

12. The apparatus according to claim 11, further comprising a temperature adjusting circulation system configured to adjust a temperature of the gas and circulate the gas in a circulation channel including the interior of said chamber,
wherein said chemical filter and said removal member are arranged in the circulation channel of said temperature adjusting circulation system.

13. An exposure apparatus which exposes a substrate via a liquid, the apparatus comprising:
a stage configured to hold the substrate and to be able to move between a measurement area in which the substrate is measured and an exposure area in which the substrate is exposed; and
an exhaust unit configured to exhaust a gas in the exposure area,
said exhaust unit including a removal member configured to remove a volatile component which volatilizes from the liquid and is contained in the gas in the exposure area.

14. The apparatus according to claim 13, further comprising one of a partition plate configured to partition the measurement area and the exposure area, and a forming unit configured to form an air curtain which partitions the measurement area and the exposure area.

15. A device fabrication method comprising steps of:
exposing a substrate using an exposure apparatus; and
performing a development process for the substrate exposed,
wherein said exposure apparatus includes:
a projection optical system configured to project a pattern of a reticle onto the substrate via a liquid;
a liquid supply unit configured to supply the liquid between said projection optical system and the substrate;
a blowing nozzle which is arranged around said projection optical system on a side of the substrate and configured to blow a gas around the liquid supplied between said projection optical system and the substrate; and
an exhaust unit configured to exhaust the gas in a space between said blowing nozzle and the liquid supplied between said projection optical system and the substrate,
said exhaust unit including a removal member configured to remove a volatile component which volatilizes from the liquid and is contained in the gas in the space.

16. A device fabrication method comprising steps of:
exposing a substrate using an exposure apparatus; and
performing a development process for the substrate exposed,
wherein said exposure apparatus includes:
an exposure apparatus main unit configured to expose the substrate via a liquid;
a chamber configured to accommodate said exposure apparatus main unit; and
an exhaust unit configured to exhaust an internal gas of said chamber to the outside through an exhaust channel,
said exhaust unit including a removal member configured to remove a volatile component which volatilizes from the liquid and is contained in the gas.

17. A device fabrication method comprising steps of:
exposing a substrate using an exposure apparatus; and
performing a development process for the substrate exposed,
wherein said exposure apparatus includes:
an exposure apparatus main unit configured to expose the substrate via a liquid;
a chamber configured to accommodate said exposure apparatus main unit;
an exhaust unit configured to exhaust an internal gas of said chamber to the outside through an exhaust channel;
a heat exchanger which is arranged in an exhaust channel of said exhaust unit and configured to cool the gas to not more than a temperature, at which a volatile component which volatilizes from the liquid and is contained in the gas condenses; and
a recovery unit configured to recover the liquid cooled and condensed by said heat exchanger.

18. A device fabrication method comprising steps of:
exposing a substrate using an exposure apparatus; and
performing a development process for the substrate exposed,
wherein said exposure apparatus includes:
an exposure apparatus main unit configured to expose the substrate via a liquid;
a chamber configured to accommodate said exposure apparatus main unit;
an exhaust unit configured to exhaust an internal gas of said chamber to the outside through an exhaust channel; and
a decomposing unit configured to decompose a volatile component, which volatilizes from the liquid and is contained in the gas, in the exhaust channel of said exhaust unit.

19. A device fabrication method comprising steps of:
exposing a substrate using an exposure apparatus; and
performing a development process for the substrate exposed,
wherein said exposure apparatus includes:
an exposure apparatus main unit configured to expose the substrate via a liquid;
a chamber configured to accommodate said exposure apparatus main unit;
a chemical filter which is arranged in a flow channel of an internal gas of said chamber and configured to remove a chemical impurity contained in the gas; and
a removal member which is set upstream of said chemical filter in a direction in which the gas flows, has a chemical property different from a chemical property of said chemical filter, and is configured to remove a volatile component which volatilizes from the liquid and is contained in the gas.

20. A device fabrication method comprising steps of:
exposing a substrate using an exposure apparatus; and
performing a development process for the substrate exposed,
wherein said exposure apparatus includes:
a stage configured to hold the substrate and to be able to move between a measurement area in which the substrate is measured and an exposure area in which the substrate is exposed via a liquid; and
an exhaust unit configured to exhaust a gas in the exposure area,
said exhaust unit including a removal member configured to remove a volatile component which volatilizes from the liquid and is contained in the gas in the exposure area.
